(19) United States
(12) Patent Application Publication
(10) Pub. No.: US 2012/0102253 A1
(43) Pub. Date: Apr. 26, 2012

(54) DATA STORAGE DEVICE

(75) Inventor: ZI-YU ZHAN, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD., Shenzhen City (CN)

(21) Appl. No.: 12/954,695

(22) Filed: Nov. 26, 2010

(30) Foreign Application Priority Data
Oct. 21, 2010 (CN) 201010514490.9

(51) Int. Cl. G06F 13/14

(52) U.S. Cl. 710/305

(57) ABSTRACT

A data storage device includes a number of storage units, a main universal serial bus (USB) interface connected to the storage units and cooperating with the storage units to form a main USB memory, and a number of branch USB interfaces corresponding to the storage units. Each branch USB interface is connected to a corresponding storage unit, and cooperates with the corresponding storage unit to form a branch USB memory. According to employing the branch USB interfaces and the storage units, the data storage device can function as several independent USB memories, to meet the need of using several USB memories at the same time.

### BACKGROUND

1. Technical Field

The present disclosure relates to data storage devices, and particularly to a data storage device with a plurality of universal serial bus (USB) interfaces.

2. Description of Related Art

When a computer or server undergoes testing during manufacture, all of the USB connections of the computer or server being tested, except keyboard and mouse USB connections, should be connected to USB memories, to test read and write capabilities. However, a USB memory, such as a USB flash drive, usually only has one USB interface, so either the USB connections must be tested one at a time or several USB memories must be provided, which is inconvenient and increases test cost.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of a data storage device in accordance with an embodiment.

FIG. 2 is a block diagram of the data storage device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

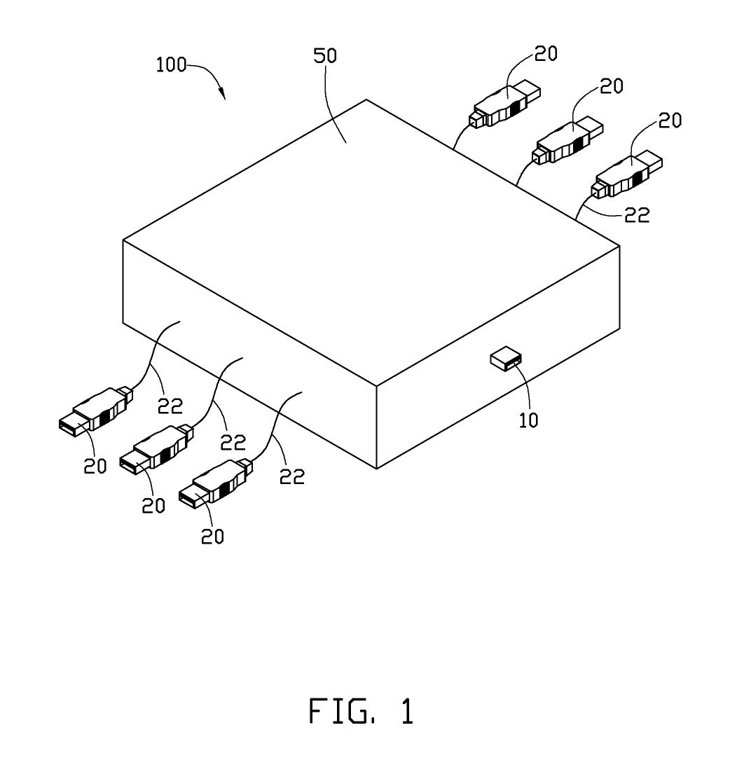

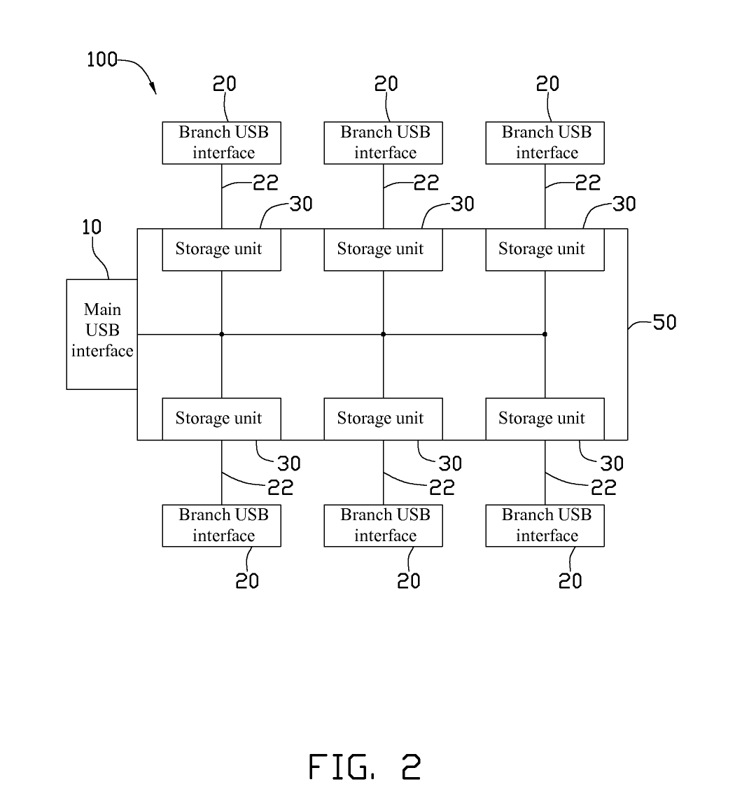

Referring to FIGS. 1 and 2, an embodiment of a data storage device 100 includes a main universal serial bus (USB) interface 10, a plurality of branch USB interfaces 20, and a plurality of storage units 30 corresponding to the branch USB interfaces 20. The main USB interface 10 is connected to the storage units 30, and cooperates with the storage units 30 to form a main USB memory. Storage capacity of the main USB memory is equal to a sum of the storage capacity of each of the storage units 30. Each branch USB interface 20 is connected to a corresponding storage unit 30, and cooperates with the corresponding storage unit 30 to form a branch USB memory. Storage capacity of each branch USB memory is equal to the storage capacity of a corresponding storage unit 30. In one embodiment, the storage capacity of each storage unit 30 is the same; therefore, storage capacity of each branch USB memory is the same. In other embodiments, the storage capacity of each storage unit 30 can be adjusted according to actual need.

The data storage device 100 further includes a body 50. The main USB interface 10 is mounted on and exposed through the body 50, the storage units 30 are received in the body 50, and the branch USB interfaces 20 are located out of the body 50. Each branch USB interface 20 is connected to a corresponding storage unit 30 by a cable 22.

When many USB memories are needed at the same time, the branch USB interfaces 20 are inserted into corresponding USB connectors (not shown). In this condition, the data storage device 100 functions as several independent USB memories.

When a single USB memory is needed, the main USB interface 10 or anyone of the branch USB interfaces 20 is inserted into a corresponding USB connector (not shown). In this condition, the data storage device 100 functions as a single USB memory.

As detailed above, according to employing the branch USB interfaces 20 and the storage units 30, the data storage device 100 can function as several independent USB memories, to meet the need of using several USB memories at the same time.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A data storage device comprising:
a plurality of storage units;
a main universal serial bus (USB) interface connected to the plurality of storage units, and cooperating with the plurality of storage units to form a main USB memory; and
a plurality of branch USB interfaces corresponding to the plurality of storage units, wherein each branch USB interface is connected to a corresponding storage unit, and cooperates with the corresponding storage unit to form a branch USB memory.

2. The data storage device of claim 1, further comprising a body, wherein the main USB interface is mounted on and exposed through the body, the storage units are received in the body, and the plurality of branch USB interfaces are located out of the body; and wherein each branch USB interface is connected to a corresponding storage unit by a cable.
